(19) United States
(12) Patent Application Publication
(10) Pub. No.: US 2026/0307359 A1
(43) Pub. Date: Oct. 8, 2026

(54) Acrylic and Silicone Foam Composites

(71) Applicant: Henry Company, LLC, Kimberton, PA (US)

(72) Inventors: Alex Ionkin, Kennett Square, PA (US); Divya Chopra, West Chester, PA (US)

(21) Appl. No.: 19/395,169

(22) Filed: Nov. 20, 2025

Related U.S. Application Data
(60) Provisional application No. 63/723,004, filed on Nov. 20, 2024.

(51) Int. Cl. B32B 5/20

(52) U.S. Cl. CPC B32B 5/20; B32B 2266/0242; B32B 2266/06

(57) ABSTRACT

The present invention relates to the field of insulation, and in particular, relates to the insulation of preferably the exterior surfaces of residential, industrial, institutional, or commercial buildings using silicone spray foam systems. In another aspect, the invention relates to isocyanate-free foams used for thermal insulation, flame-retardancy, and water resistance. The invention further pertains to foams and foam composites. More specifically, this invention pertains to a composite foam sandwich comprising at least one foam comprising predominantly silicone and at least one foam predominantly comprising acrylic. This invention also relates to methods of making such foams and foam composites and to products prepared from such foam composites. In one aspect, the invention pertains to using such foam composites in the building and the construction industry.

### CROSS REFERENCE TO RELATED APPLICATIONS

This application claims benefit under 35 U.S.C. § 119(e) of Provisional U.S. Patent Application No. 63/723,004, filed Nov. 20, 2024, the contents of which are hereby incorporated by reference in its entirety.

### FIELD OF THE INVENTION

The present invention relates to the field of insulation, and in particular, relates to the insulation of preferably the exterior surfaces of residential, industrial, institutional or commercial buildings using silicone spray foam systems. In another aspect, the invention relates to isocyanate-free foams used for thermal insulation, flame-retardancy, and water resistance. The invention further pertains to foams and foam composites. More specifically, this invention pertains to a composite foam sandwich comprising at least one foam comprising predominantly silicone and at least one foam predominantly comprising acrylic. This invention also relates to methods of making such foams and foam composites and to products prepared from such foam composites. In one aspect, the invention pertains to using such foam composites in the building and the construction industry

### BACKGROUND OF THE INVENTION

In the construction of most buildings, and in particular, in residential housing applications, walls are constructed using structural lumber, such as 2×4, or 2×6 wood studs, to which an external sheathing of a wood or wood composite panel is applied. By insulating the cavities created in the stud walls using, for example, fiberglass batt insulation, R-values of between 10 and 20 can be obtained. Fiberglass batts, however, can allow air leakage around the batts (if not properly installed), and provide little resistance to air, water vapor or water permeability. As a result, the use of an air, water, and water vapor barrier on the interior of the building is required. This prevents moist air from contacting the cool exterior wall, and creating condensation within the wall cavity.

The use of polyurethane foam has become more common in building construction applications. In these systems, the stud wall cavities are filled with a liquid spray foam material which expands to fill the wall cavity, or the material is applied to the outside of the wall. Compared to fiberglass batt insulation, these spray foam materials are generally superior at filling the voids in the wall cavity, and thus, they generally reduce the possibility of air leakages within the wall.

These types of products are generally applied on-site and are the foamed reaction products of an isocyanate and a polyol which are reacted together to create the foamed product. Generally, the closed cell spray foamed material is applied using a hydrofluorocarbon (HFC) blowing agent so as to create a medium density closed cell material having a foam density of about 2 lb. per cubic foot and an R-value of 5 to 6.5 per inch. When a thickness of 2 inches or more is installed, this material typically acts as both a vapor barrier and an air barrier, and thus can prevent moisture from the interior of the building from reaching the cool exterior walls.

However, with the establishment and continued evolution of the Montreal Protocol, foam blowing agents (FBAs) used for closed-cell polymeric foam products have changed dramatically over the last two decades. Beginning in 1989, both thermoset and thermoplastic foam industries worldwide moved away from chlorofluorocarbons (CFCs) in favor of hydrochlorofluorocarbons (HCFCs), such as HCFC-141b and 142b. These alternatives were chosen as they provided a greatly decreased ozone depletion potential (ODP). Today, countries have either eliminated the use of, or are in the process of phasing out, HCFCs in foam applications, in order to meet the amended Montreal Protocol's regulated goal of zero ODP foam blowing agents. This has led to the widespread use of third-generation zero ODP hydrofluorocarbon (HFC) foam blowing agents, such as HFC-245fa, HFC-365mfc, and HFC-134a. However, maturing environmental awareness has put even such HFCs under speculation and, according to the amended Montreal Protocol, will not be suitable for use (based on application and country), due to their moderate global warming potential (GWP). As a result, many countries and polymeric foam manufacturers find themselves in need of a zero ODP and low GWP foam expansion agent.

While polyurethane foam and its manufacture may address some of the above issues, spray polyurethane foam is created by mixing polyol resin and isocyanate in the spray nozzle in 2-component systems and moisture-cured in case of aerosol 1 component systems. However, the polyurethane foam product faces regulation changes that restrict the use of toxic isocyanates, with its supply also a problem. Impending changes in governmental regulations imply adjusted safety labelling, disposal as hazardous waste, and a lowering of the free monomeric content below 1% w/w, all of which are key drivers for industrial manufacturers to develop isocyanate-free PU foam products. In addition, PU foams require complex spray rigs, full PPE, and limited public traffic for application in construction jobs. This adds to the job set-up cost and interruption to the business.

On the other hand, silicone foam does not require an isocyanate for its making. Starting ingredients for the silicone foams are environmentally friendlier than ones for polyurethane foams. Polyurethane foams typically require applying fluorinated blowing agents to preserve starting isocyanates used as a source of CO₂ for the foaming process.

Consequently, there is a need to replace polyurethane foam with more compliant and environmentally friendly foam materials in home building envelope industry, and optionally which do not require fluorinated blowing agents during forming process. The present invention described herein, addresses these issues.

More specifically, the present invention relates to preparing composite foam sandwiches comprising silicone foam and acrylic foam. To be clear, the silicone foam of the present invention can be prepared with fluorinated blowing agents or non-fluorinated blowing agents, or combinations thereof.

### SUMMARY OF THE INVENTION

In one aspect, this invention relates to a composite foam sandwich comprising:
(i) at least one foam comprising predominantly silicone, designated as As; and
(ii) at least one foam predominantly comprising acrylic, designated as Bs.

In another aspect, this invention relates to the composite foam sandwich as recited above, wherein the structure is expressed as follows:

(AiBj)n, wherein:
A designates a foam predominantly comprising silicone;
B designates a foam predominantly comprising acrylic;
i=0-5; j=0-5; and n=1-10.

In yet another aspect, this invention relates to the composite foam sandwich as recited above, comprising one of the following structures:
A1/B1; A1/B1/A2; B1/A1/B2; A1/B1/B2; A1/A2/B1; and A1/A2/B1/B2.

In one aspect, this invention relates to the composite foam sandwich as recited above, wherein the foam comprising predominantly acrylic comprises reaction product of a reaction mixture comprising:
(a) at least one multi-functional Michael donor;
(b) at least one multi-functional Michael acceptor; and
(c) at least one base catalyst.

In another aspect, this invention relates to the composite foam sandwich as recited above, wherein:
(a) the multi-functional Michael donor is selected from methyl acetoacetate, ethyl acetoacetate, t-butyl acetoacetate, other alkyl acetoacetates, 2-acetoacetoxyethyl (meth)acrylate, butane diol diacetoacetate, 1,6-hexanediol diacetoacetate, neopentylglycol diacetoacetate, the diacetoacetate of 4,8-Bis(hydroxymethyl)tricyclo[5.2.1.0]decane, 2-methyl-1,3-propanediol diacetoacetate, diethylene glycol diacetoacetate, ethylene glycol diacetoacetate, propylene glycol diacetoacetate, dipropylene glycol diacetoacetate, polyethylene glycol diacetoacetate, polypropylene glycol diacetoacetate, cyclohexanedimethanol diacetoacetate, other diol diacetoacetates, trimethylol propane triacetoacetate, pentaerythritol triacetoacetate, glycerol trisacetoacetate, trimethylolethane triacetoacetate, other triol triacetoacetates, diacetoacetates of triols, tetra-, penta-, and higher acetoacetates of polyols (i.e., polyols on which four, five, or more hydroxyl groups are linked to acetoacetate groups through ester linkages), pentaerythritol tetraacetoacetate, glucose tetraacetoacetate, glucose pentaacetoacetate, dipentaerythritol pentaacetoacetate, and dipentaerythritol hexaacetoacetate; and
(b) the multi-functional Michael acceptor is selected from one or more of residues of (meth)acrylic acid, (meth)acrylamide substituted versions thereof, combinations thereof, capable of attaching to the multi-functional Michael acceptor molecule through an ester linkage or a poly-functional (meth)acrylate, 1,4-butanediol diacrylate, 1,6-hexanediol diacrylate, neopentyl glycol diacrylate, diethylene glycol diacrylate, triethylene glycol diacrylate, tetraethylene glycol diacrylate, polyethylene glycol diacrylate, dipropylene glycol diacrylate, tripropylene glycol diacrylate, cyclohexane dimethanol diacrylate, alkoxylated hexanediol diacrylate, alkoxylated cyclohexane dimethanol diacrylate, propoxylated neopentyl glycol diacrylate, trimethylolpropane triacrylate, di(trimethylolpropane) tetraacrylate, ethoxylated trimethylolpropane triacrylate, propoxylated trimethylolpropane triacrylate, acrylated polyester oligomer, bisphenol A diacrylate, diacrylate of diglycidyl ether bisphenol-A, ethoxylated bisphenol A diacrylate, tris(2-hydroxyethyl) isocyanurate triacrylate, acrylated aliphatic urethane oligomer, acrylated aromatic urethane oligomer, and mixtures thereof.

In yet another aspect, this invention relates to a composite foam sandwich, wherein:
the Michael acceptor is selected from diacrylate of diglycidyl ether bisphenol-A, di(trimethylolpropane) tetraacrylate, and mixtures thereof; and
the Michael donor is selected from trimethylolpropane acetoacetate, 1,1,3,3-tetramethylguanidine, and mixtures thereof.

Also provided herein are methods of making acrylic silicone foam composite materials, comprising: (a) forming a first foam layer comprising predominantly silicone by mixing at least one foamable silicone pre-polymer with at least one blowing agent selected from fluorinated or non-fluorinated compounds, and curing the mixture to form a silicone foam; (b) forming a second foam layer comprising predominantly acrylic by reacting a mixture comprising at least one multi-functional Michael donor, at least one multi-functional Michael acceptor, and at least one base catalyst to form an acrylic foam; and (c) combining the silicone foam and the acrylic foam to form a composite foam sandwich structure.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 describes the Michael Addition as the chemical foundation of preparing acrylic foams of the present invention. In one embodiment, the acrylic (Morcure™ 2000 or di-trimethylpropane tetraacetate) and the acetoacetate (the trimethylol propane triacetate with a surfactant and a catalyst) reactants are shown, which, in presence of basic catalyst and/or UV provide the acrylic foam with cyclopentane as the blowing agent.

FIG. 2 depicts two acrylic compounds, Morcure™ 2000 and di(trimethylolpropane) tetraacrylate; and two acetoacetates, that is trimethylolpropane triacetoacetate and 1,1,3,3-tetramethylguanidine and blowing agents namely cyclopentane and the surfactant DC 193.

FIG. 3 depicts an acrylic foam prepared in the laboratory.

FIG. 4 shows an acrylic mold prepared in a 4×4 inch mold.

FIG. 5 shows acrylic foam samples.

FIG. 6 shows foam from a closed view.

FIG. 7 shows acrylic foam under an optical microscope.

FIG. 8 shows acrylic foam under an optical microscope with a blue dye.

FIG. 9 shows acrylic foam formulations with Morcure™ 2000 and di(trimethylolpropane) tetraacrylate; and two acetoacetates, that is trimethylolpropane triacetoacetate and 1,1,3,3-tetramethylguanidine and blowing agents namely Opteon™ 1100 (CF₃CH═CHCF₃) and the surfactant DC 193.

FIG. 10 shows acrylic foam formation at a 2-g scale in a bottle with Opteon™ 1100 blowing agent.

FIG. 11 shows a composite sandwich of silicone foam coating on both sides of an acrylic foam, which can be used for building and construction purposes.

FIG. 12 shows the various silicone foams used for coatings in a composite sandwich.

FIG. 13-15 shows an optical image of the silicone foam coating with dimensions of the cells.

FIG. 16 shows a silicone foam with ePP to improve the R-value of the foam.

FIG. 17 shows a silicone foam with ePS to improve the foam's R-value.

FIG. 18 shows a silicone foam with aerogel.

FIG. 19 shows a table that provides the R value of previously and currently measured samples.

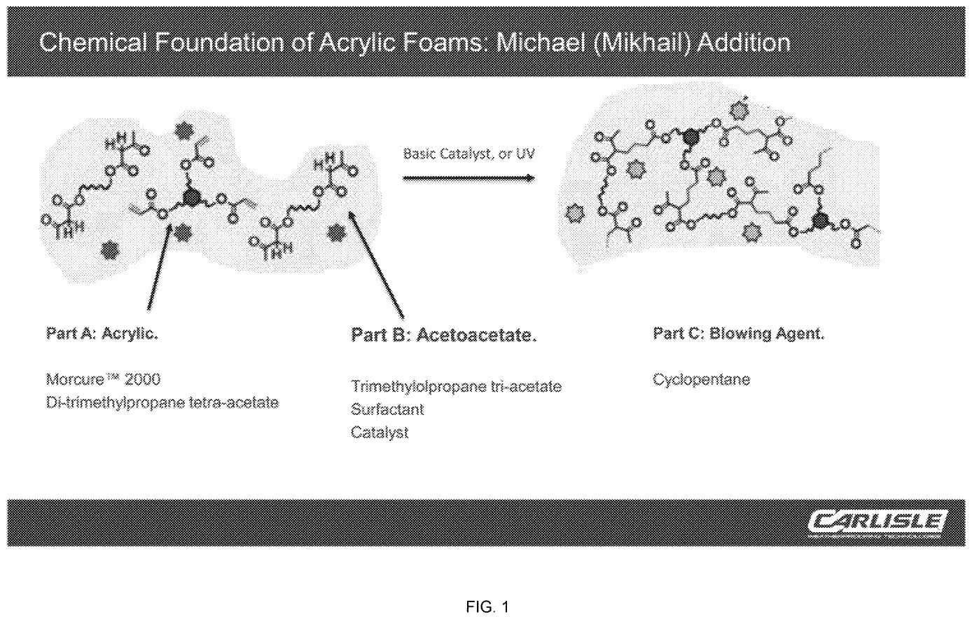

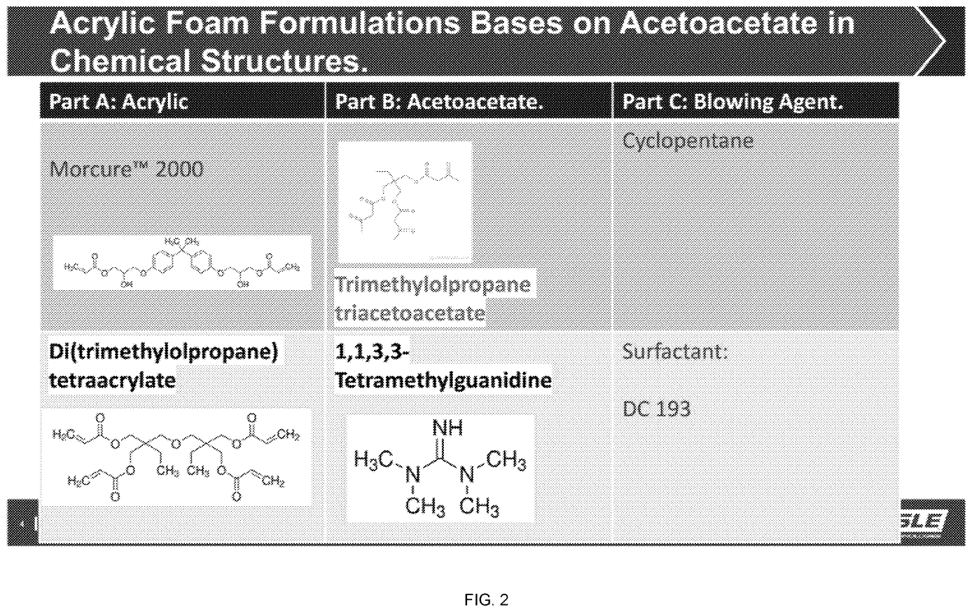

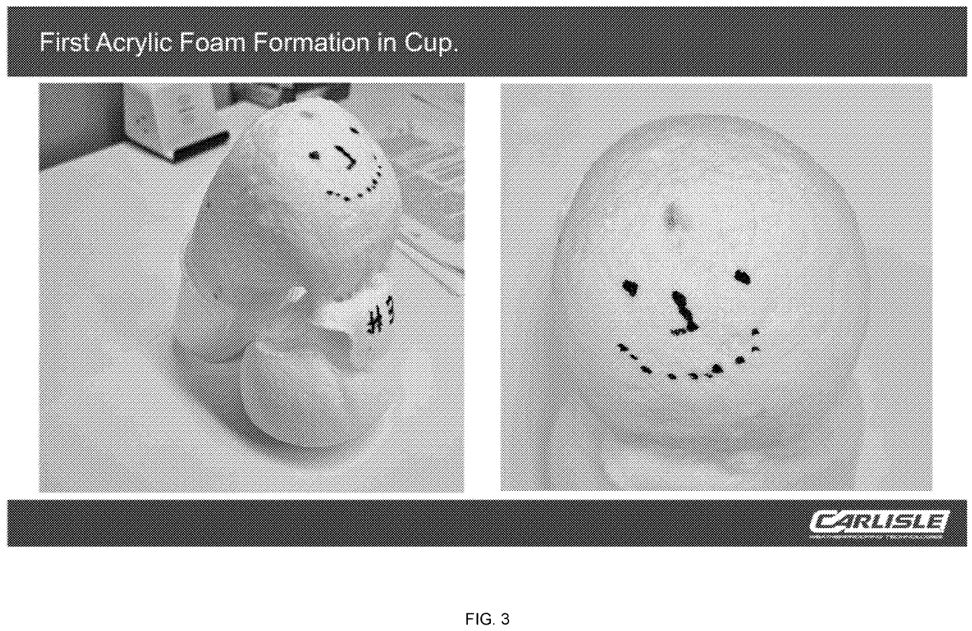

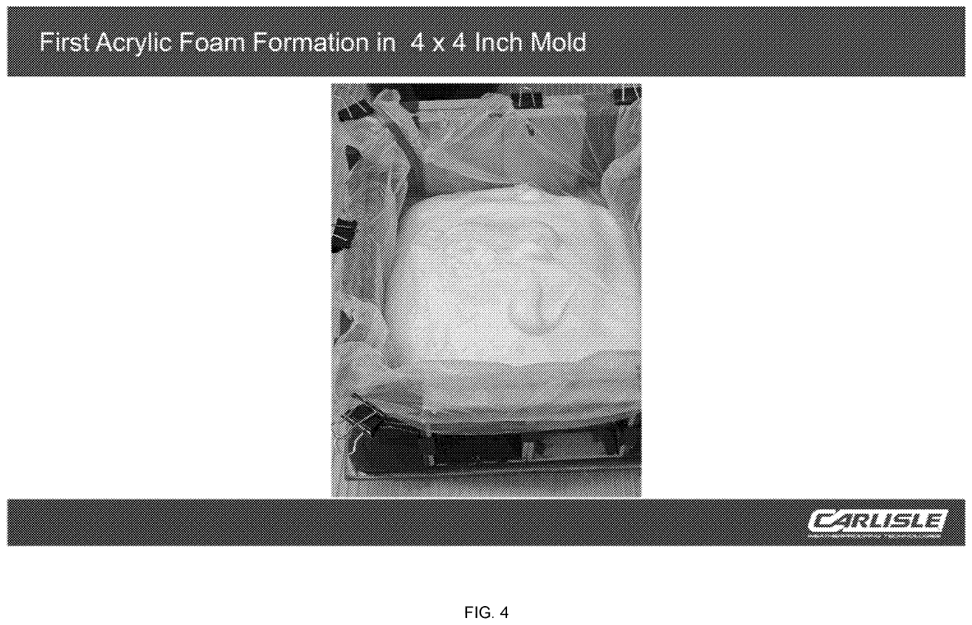

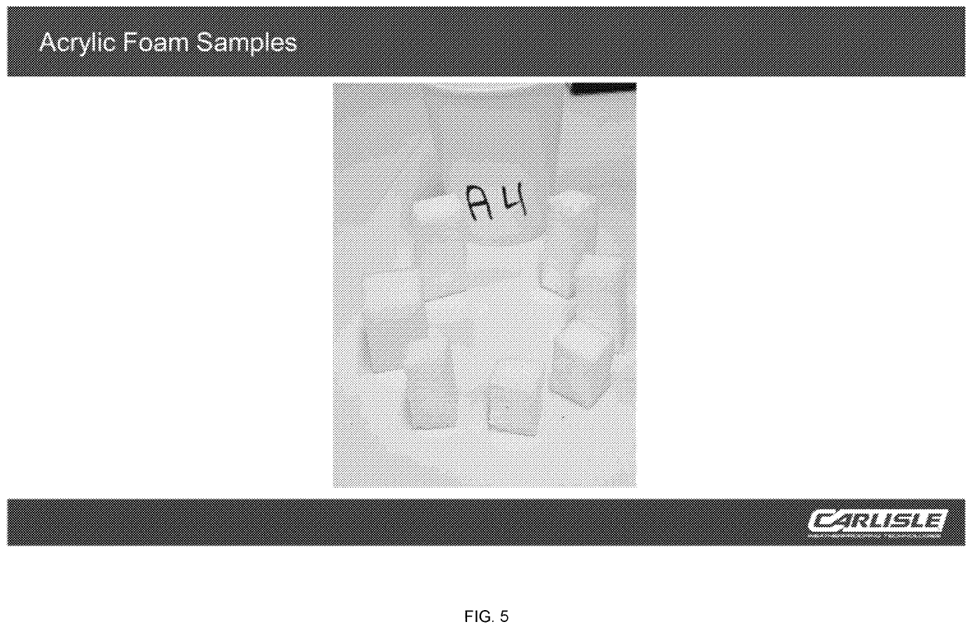

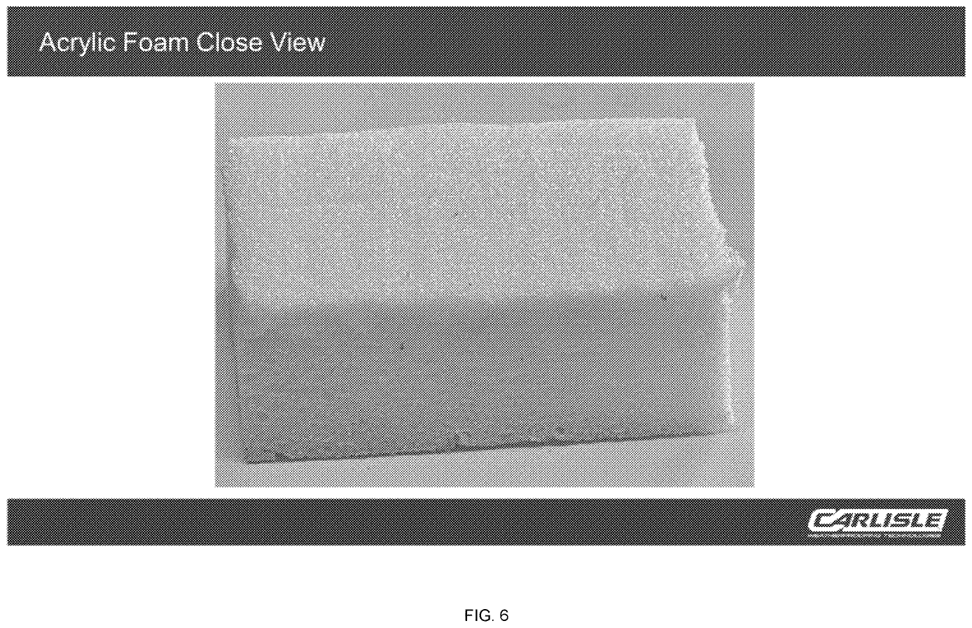

### DETAILED DESCRIPTION OF ILLUSTRATIVE EMBODIMENTS

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B—F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including, but not limited to logical flow or arrangement of steps; interpretations derived from the grammatical organization, syntax, or punctuation; and the quantity or variety of embodiments detailed in the specification. The description of the invention should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present), and B is false (or not present), A is false (or not present), and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entireties are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

The following describes exemplary embodiments of the present invention in the building construction context, which pertains to insulation, water permeation, and fire-retardation, among other things.

U.S. Provisional Patent Application No. 63/678,374 titled Silicone Foams Prepared Using Non-Fluorinated Blowing Agents is incorporated by reference in its entirety.

All patent references cited in this document are also incorporated by reference into this document as if they were set forth fully herein.

In one general aspect, this invention relates to a composite foam sandwich comprising:
(i) at least one foam comprising predominantly silicone, designated as As; and
(ii) at least one foam predominantly comprising acrylic, designated as Bs.

In another embodiment, this invention composite foam sandwich as recited in claim 1, wherein the structure is expressed as follows:

(AiBj)n, wherein:
A designates a foam predominantly comprising silicone;
B designates a foam predominantly comprising acrylic;
i=0-5; j=0-5; and n=1-10.

Further, this invention relates to the composite foam sandwich as recited above, comprising one of the following structures:
A1/B1; A1/B1/A2; B1/A1/B2; A1/B1/B2; A1/A2/B1; and A1/A2/B1/B2.

### A. Silicone Foams

### Definitions

Silicone polymers and pre-polymers as well as the blowing agents are defined in their respective sections, infra.

By “open-celled” structure is meant that the resulting foam is substantially open-celled in its structure.

By “closed-cell” structure or close-cell structure is meant that the resulting foam is substantially close-celled.

By “substantially” in the above context is meant that at least 20% of the cells in the resulting foam are one way or the other way.

By a “hybrid-cell” structure is mean that the resulting foam has both open- and close-celled structure substantially speaking.

By a “silicone pre-polymer” is meant a material that is capable of polymerizing into a higher molecular weight polymer that is higher than the silicone-prepolymer. The pre-polymer can me monomeric, dimeric, trimeric, or oligomeric.

By “pre-foam mix” or “foam pre-mix” is meant the material that comprises at a minimum the silicone pre-polymer, and optionally, at least one blowing agent. The premix can also have other optional ingredients in it, for example, a second blowing agent, an emulsifier, a surfactant, a surface tension depressant, a wetting agent, a chemically active blowing agent, a catalyst, a filler material, a viscosity modifier, and a physically active agent such as a microbial mitigation agent.

By “foamable” is meant that the silicone pre-polymer is capable of forming into a foam.

By “non-fluorinated” blowing agent is meant that the blowing agent used for preparing the foam material does not comprise one or more fluorine atoms in its chemical structure.

By “partially-cured” silicone polymer is meant that the foamed silicone polymer is not substantially cured. By “substantially cured” is meant that the silicone polymeric foam is more than 80% cured at that given temperature, from a chemical standpoint.

This invention relates to a pre-foam mix comprising:
(i) at least one foamable silicone pre-polymer; and
(ii) one blowing agent comprising at least one fluorinated or non-fluorinated blowing agent.

The silicone polymers and the blowing agents are described below.

### Silicones

In the silicone prepolymer, the silicone pre-polymer concentration can range from 100% to 60%. Stated differently, the silicone pre-polymer concentration the silicone premix optionally comprising unfluorinated blowing agents is one of the numbers in terms of weight percent of the premix: 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

In one embodiment, the silicone pre-polymer concentration by weight is within a range defined by any two numbers above, including the endpoints of such a range.

Silicones used for preparing the foam for the present invention include Silicone polymers represent inorganic/organic hybrid polymers with Si—O—Si-typical inorganic backbone and organic Methyl or Phenyl groups attached to the silicon atoms (Me-Si or Ph-Si). Silicone polymers do not require toxic isocyanate starting materials. Due to inorganic/organic nature of the silicone polymers, they form special “self-extinguishing” class of the polymers. They don't require additions of flame-retardants in many applications. Silicone foams are synthesized by using hydrogen gas as a blowing agent. Source of the hydrogen is incorporated in the one of the silicone polymers with Si—H fragment. Si—H moiety typically reacts with Si—OH fragment of other silicone polymer in the foam formulation with the liberation of hydrogen gas, which acts as blowing agent. This foaming process has the limited amounts of hydrogen available for the foaming process if the silicone foam with less density desired or more silicone open foam is desired. Addition of the second or third or azeotropic blowing agents was envisioned to prepare cost-efficient silicone foams with less density and more open cell structures. Addition of low-boiling non-fluorinated acetals, for example, methylal was explored and claimed for the silicone foam production in this application.

Silicones for the present invention include Dow Chemical's Dowsil 3-6548 and Elkem silicones 3230A, 3230B, 3242A, and 3242B. Also included are the Bluestar Silicones from Elkem.

Other silicones pre-polymers and foams used for preparing foam include the ones described in the following references, which are incorporated in relevant parts, by reference, here:

U.S. Pat. Nos. 9,056,953; 10,829,609; 5,153,231; 4,719,243; 10,744,225; 3,428,580; ES2787849T3; U.S. Pat. No. 10,857,758; US20160053069; US20100192289; and CA3045033.

For comparison purposes the following silicone foams were used:

### International Silicone Foams (ISC)

Class of Low-Density Foam
Cell structure: Open.
Sealing: Excellent.
Density: 150 (kg/m3) or 9.36 (pcf)
Thermal Conductivity: 0.09 W/m∘k

### Rogers Corporation

Class of Low-Density Foam (kSil 200)
Cell structure: Hybrid (Open/Closed).
Sealing: Excellent.
Density: 150 (kg/m3) or 9.36 (pcf)
Thermal Conductivity: 0.064 W/m∘k

In one embodiment, this inventio relates to preparing a mixture of the blowing agents to obtain a desired density and/or desired cell-structure in the silicone foams, for example, open, closed, or hybrid. In one embodiment, one or more or all of the blowing agents are all non-fluorinated. In one embodiment, the blowing agents are fluorinated. In another embodiment, one or more of the blowing agents may be fluorinated.

Silicone foams can be prepared comprising expanded polypropylene, expanded polystyrene, and/or aerogel. These additives can range from about 0.2% to about 15% of the foam by its weight. In other words, the additives can be any one of the following numbers including the endpoints of such numbers as measured in percent weight of such additives in the silicone foam:
0.2, 0.3, 0.4, 0.5, 0.6, 0.7, 0.8, 1, 2, 3, 4, 5, 6, 7, 8, 9, 10, 11, 12, 13, 14, and 15.

In another embodiment, the additive weight percent is a number that is within a range defined by any two numbers above, including the endpoint of such ranges.

### Blowing Agents

In one embodiment, the blowing agent comprises one or more of the following non-fluorinated compounds:
methylal, ethylal, propylal, butylal, tetraoxaundecane, 1,3-dioxolane, 2-ethylhexylal, glycerol formal, dimethyl acetal, fructone, mixtures thereof, and combinations thereof.

In another embodiment, the above listed blowing agents are combined with water, In one embodiment, the present invention uses methylal to prépare silicone based rigid foams, spray foams, flexible molded foams, and one-component foams to be used in the building construction industry.

In another embodiment, the following blowing agents are used in combination with the above-listed non-fluorinated blowing agents to prepare silicone-based foams, preferably for the construction industry:
methyl formate, cyclopentane, n-pentane, isopentane, HFO-1233-zd-E, HFC-245fa, HFC-365mfc, HFO-1336 mzz-Z, HFC-227ea.

In one embodiment, methylal is blended with polyols to reduce flammability. Once Methylal is blended with polyols, the blend's vapor pressure decreases and the flash point increases. Blends of polyols of higher viscosity with Methylal have a higher flash point.

HFO-1336 mzz-Z is also known as Opteon™1100 or Formacel®1100 and is purchased from the Chemours Co. of Delaware.

In one embodiment, silicone such as silicone polyether copolymer emulsifier is added to polyol-methylal blends to increase the flash point. An exemplary polyol is polyether triol. The silicone polyether can act as a surface tension depressant, wetting agent, and a foam builder.

In one embodiment, the blowing agent concentration, by weight of the silicone pre-polymer mix with the blowing agent is in the range of 0% to about 20%. Stated differently, the concentration of the blowing agent as recited above, is any one number selected from the set of following numbers in weight % concentration of the total weight of the pre-polymer mix that comprises at least one silicone pre-polymer, the blowing agent, and other ingredients:
0, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, and 20. In one embodiment, the concentration of the blowing agent as recited above is any number within a range defined by any two numbers above including the endpoints of such range.

In one embodiment, methylal is combined with one or more other blowing agents as described above to engender better miscibility of the other blowing agent, better flow, better foam uniformity, control of the cell size, and better adhesion to metallic surfaces.

In one embodiment, a cell regulator surfactant is added to the blowing agent or to the silicone pre-polymer mix with the blowing agent.

In one embodiment, methylal is used in combination with hydrogen has as the blowing agent.

Further blowing agents that can be used in the present invention include low-boiling acetals or ketals, for example, ethylal (EtO)₂CH₂; DMA (MeO)₂CH(Me) or cyclic derivatives, for example, dioxolane: [—CH₂—CH₂—O—CH₂—]. In one embodiment, these low boiling acetals or ketals are used in combination with different proportions of methylal to moderate exotherm of the silicone foam process. The control of the silicone foam exotherm, and thereby controlling the density and the closed-cell or open-cell aspect of the silicone-based foam is an aspect of the present invention.

In one embodiment, the following blowing agents are used with various combination and proportions: methylal, cyclopentane, pentane, methyl formate, and Opteon™ 1100.

In one embodiment of the invention, the following thermal blowing agents individually or as a blend are used in the silicone foams:
methylal, cyclopentane, pentane, methyl formate, and Opteon™ 1100

In another embodiment, chemically active blowing agents such as diols and triols can also be used to prepare the silicone foams, for example, 1,4-butanediol, 1,2,3-propanetriol.

In one embodiment, chemically activated blowing agents are also considered in the process described above.

Accordingly, in one aspect, the present invention provides a silicone foam for use in insulating an exterior surface of a building, wherein said silicone foam has an open-cell structure, and preferably has a foamed density of between 50-350 Kg/m³.

Preferably, the open cell structure of the foams of the present invention have a structure wherein the cells are essentially open but include some randomly occurring, solid cell walls.

In one embodiment, the open cell structure of the foams of the present invention is formed by a combination of surfactants that results in a surfactant interaction which produces both completely open and at least partially open, cell walls. In one embodiment, if measured by a method such as ASTM D6226, the open cell content of the foams of the present invention is preferably greater than 80%, and more preferably, greater than 80%.

The size of the cell can vary depending on the materials used, and the amount of blowing agent, and the like, which is used. Preferably, the foams of the present invention have a cell size of between 0.03 μm, and 1.5 μm, and more preferably between 0.1 μm and 1.0 μm.

The insulating ability (for example the “R” value) of the foam is preferably such that the silicone foam of the present invention will provide an R value of between 2 and 20 per inch of thickness. As such, typical “R” values would be between the ranges of 4 and 12 for a 2-inch thickness foam.

In an exemplary implementation of the present invention, a first silicone pre-polymer (Component A) is mixed with a second silicone pre-polymer (Component B), at room temperature or under heat, so that the two components react and foam. Preferably, the two components are mixed in the spray nozzle of a spray gun.

In another aspect, the present invention provides a semi-rigid, silicone foam, for use in insulating an exterior surface of a building, wherein said sprayed silicone foam has an open cell structure and density, as previously described with respect to the present invention.

In another aspect, the present invention provides a method for insulating the exterior surface of a building comprising spraying the exterior surface of the building with the foamed reaction mixture of one or more silicone pre-polymers in order to produce a silicone foam having an open cell structure and density, as previously described with respect to the present invention.

The general production methods to produce silicone foams are well known to the skilled artisan, as is the general chemistry for production thereof. As such, these will not be described in any specific detail.

The nature, types and amounts of blowing agents which are used in silicone foam manufacture are well known to those skilled in the art, but can include, for example, water, carbon dioxide, hydrofluorocarbons (HFCs), chlorinated fluorocarbons, hydrofluro olefins (HFOs), and the like.

In contrast, for the present invention, non-fluorinated blowing agent is the preferred blowing agent for formulations of one embodiment of the present invention. In the formulations used for preparing the silicone foams of the present invention, the non-fluorinated blowing agent will be present at a concentration of from 0.5 to 40 weight percentage of B-side component.

Alternatively, other blowing agents can be used, or combined with the non-fluorinated blowing agents such as methylal, in order to generate a gaseous material during the curing reaction. While carbon dioxide is a preferred gas for generation, other gases such as hydrogen, nitrogen, pentane, and fluorinated blowing agents such as HFOs, HFCs, or the like, may be released, or directly used, in order to form a foam with the desired density and cell shape and size.

The total amount and type of blowing agent is selected however, so as to provide a silicone foam having the desired density range.

The silicone foam material of use in the present invention can also be custom formulated and engineered for specific applications. The range of formulations includes using rigid, semi-rigid, or more preferably semi-flexible or flexible, silicone foams that may include a range of organic and inorganic reinforcing materials which may be in the form of a particle or fiber with the said reinforcing materials being in a variety of densities, sizes and regular and irregular shapes.

Additionally, other additives such as catalysts or surfactants, or the like, can be added to the reaction mixture in order to control various properties of the silicone foam.

Surfactants are also preferably included to provide the proper cell structure, and these are silicone based. However, any suitable surfactants might be used. By introducing surfactants, the foam materials can be caused to make more cells, and by proper selection of surfactants, the preferred combination of open and partially-closed cell configurations of the present invention can be achieved.

Preferred surfactants include combinations of cell opening-promoting surfactants like Evonik TEGOSTAB B8523, B8580, B84710, B8870, Ortegol 204, Ortegol 500, and Ortegol 501, and closed cell-promoting surfactants like Evonik TEGOSTAB B8408, B8453, and B8487.

Another preferred surfactant is DC 193.

Another blowing agent that is preferred in the Opteon™ 1100, which is CF₃CH═CHCF₃.

Preferably, the systems of the present invention include combinations of these types of surfactants to produce open cells have some randomly occurring, solid cell walls.

The total amount of surfactants present is preferably between 0.1 and 10% by weight of the B-side component, and more preferably, between 1 and 6%, by weight. Most preferably, the weight of the surfactant is between 2 and 4% by weight of the B-side component.

The mixture of open cell and closed cell promoting surfactants, in the total surfactant added, is preferably such that the open cell promoting surfactant accounts for between 10 to 90% by weight of the surfactant mixture.

The amount and ratio of the surfactant types is selected to provide the desired cell size, foam density, and amount of essentially open cells with some cells including some randomly occurring, solid cell walls.

Where uniformity of cell structure is required, fine organic or inorganic particles in a size range between 50 and 500 microns, may be added.

Other materials can be included in the formulations of the present invention. For example, coupling agents, such as silane or titanates, may also be included in the preparation of the composition to improve the physical properties of the material. Where other properties are desired, additional additives may be added to the composition including colorants, dry or liquid inks or pigments, fire and flame retardants, UV absorbers and protectants, antistatic agents, and such other additives as required, and which are known within the industry.

Silicone foam generally denotes a polyorganosiloxane composition in the foam form. Silicone foams preparation is described in several patent references. However, in one embodiment, the present invention uses non-fluorinated blowing agents to make the silicone foams.

With regard to silicone foams, several techniques exist for producing them. A first technique employs a condensation reaction with release of volatile by-products. This is the case in particular for systems using the condensation reaction of the SiH—SiOH type, which makes it possible to release hydrogen which then acts as a porogenic agent. For example, French patent No. FR-A-2 589 872 describes a silicone foam precursor composition comprising an organosilicon polymer comprising siloxane units having hydroxyl groups bonded to the silicon, an organosilicon polymer comprising siloxane units having hydrogen atoms bonded to the silicon, a catalyst, for example a tin compound, and a finely divided filler comprising silica which has been treated to become hydrophobic.

A variant described in U.S. Pat. No. 3,923,705 consisted in providing compositions comprising polydiorganosiloxanes bearing hydrogen atoms bonded to the silicon available for a condensation reaction with polydiorganosiloxanes bearing hydroxyl groups bonded to the silicon (silanols) in the presence of a platinum catalyst. This reaction thus makes it possible to construct the network while producing hydrogen gas necessary for the formation of a silicone foam. In this type of formulation, the formation of gas is proportional to the rate of crosslinking and consequently the density of the foams obtained is difficult to control, thus explaining the difficulties in obtaining low-density foams by this technique.

According to another variant described in U.S. Pat. No. 4,189,545, silicone foams are prepared from a composition comprising water, a polydiorganosiloxane bearing vinyl groups bonded to the silicon, a polydiorganosiloxane containing hydrogen atoms bonded to the silicon and borne by units in the chain and not exclusively at the chain end, in order to be able to act as a crosslinking agent. The water reacts with the polysiloxane comprising hydride functions, thus producing hydrogen gas and a silanol. The silanol then reacts with the polydiorganosiloxane comprising hydride functions via a condensation reaction, thus generating a second molecule of hydrogen gas, while another polydiorganosiloxane bearing vinyl groups bonded to the silicon will simultaneously react, via an addition reaction, with another polydiorganosiloxane comprising a hydride function, thus participating in the construction of the network of the silicone foam.

In U.S. Pat. No. 4,590,222, silicone foams are prepared from a composition comprising a polydiorganosiloxane, a resin, a platinum-based catalyst, an organohydro-siloxane, a polyorganosiloxane bearing hydroxyl groups on the chain-end units, a filler and an organic alcohol.

### EXPERIMENTAL

Methylal showed good solubility in both parts “A” and “B” of the silicone pre-polymers. Thus, calculated amount of blowing agent was pre-dissolved in part “A” and/or Part “B”, and above parts are mixed in 50-gram quantities each with vigorous mixing. After initial bubbling formation, the resultant mixture was casted into the molding forms. Curing of the foam at room temperature takes about half an hour or even shorter. Complete curing of surface tackiness may take 1 or 2 days at room temperature. After that silicon foams can be cut in smaller pieces for the analysis.

Samples of the foams prepared from Elkem pre-polymers are presented in the figures.

For the present experiments, silicones were purchased commercially from the several manufacturers, for example, Elkem and Dow Chemicals.

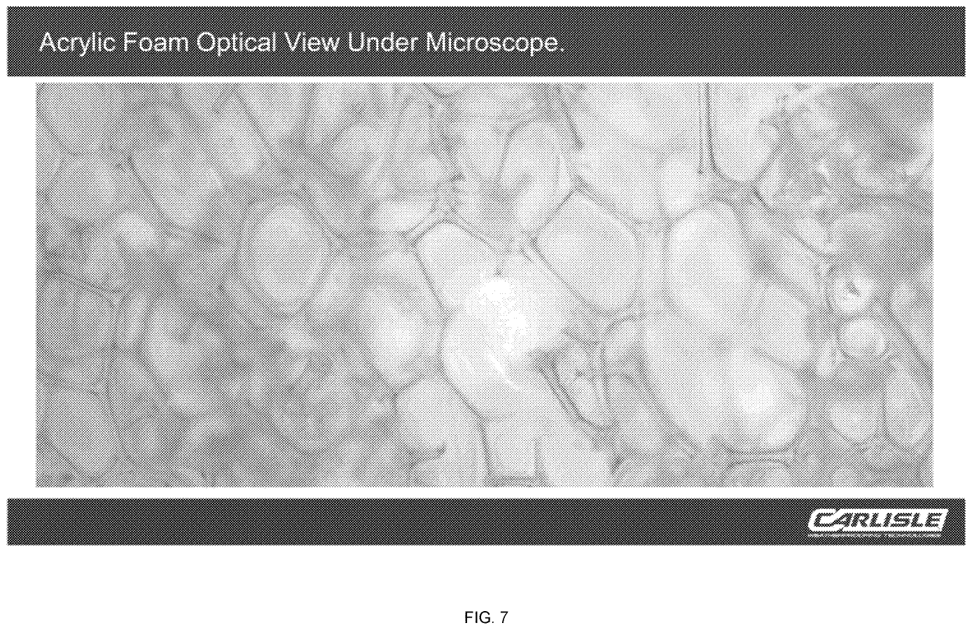

FIG. 7 shows the density decrease of the silicone foam prepared from Elkem 3230, Elkem 3242, and Dowsil 3-6548 silicone prepolymers when methylal is used as blowing agent. A decrease of about 53% was found with a 10% concentration of methylal over 0% methylal concentration.

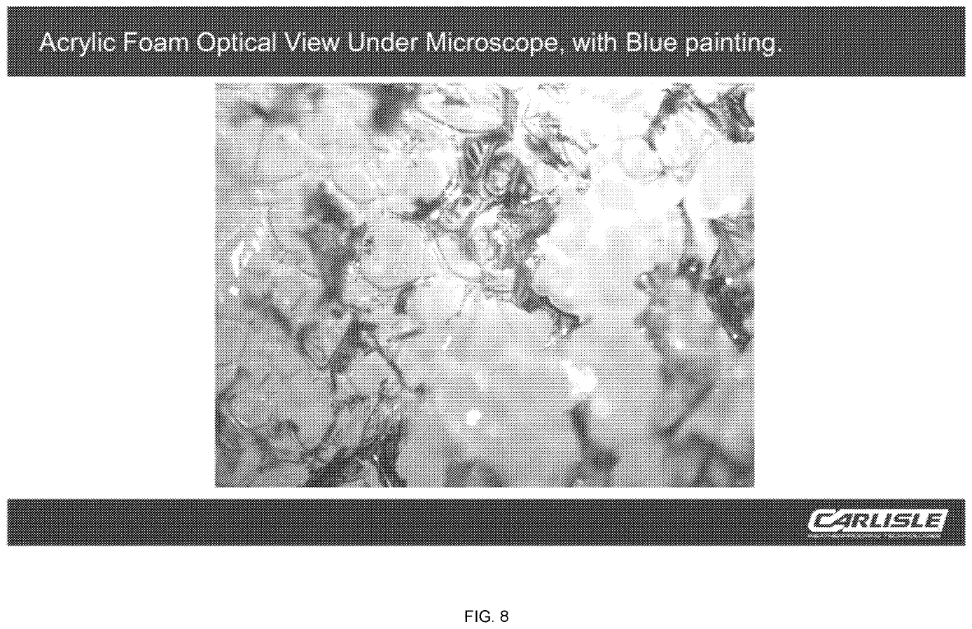

FIG. 8 shows methyl formate as the blowing agent and Elkem 3230 and 3242 as the silicone The density was reduced from 172 Kg/m³ prepolymers. There was a 50% reduction in density for both silicone foams when 0% blowing agent was used versus when 10% was used.

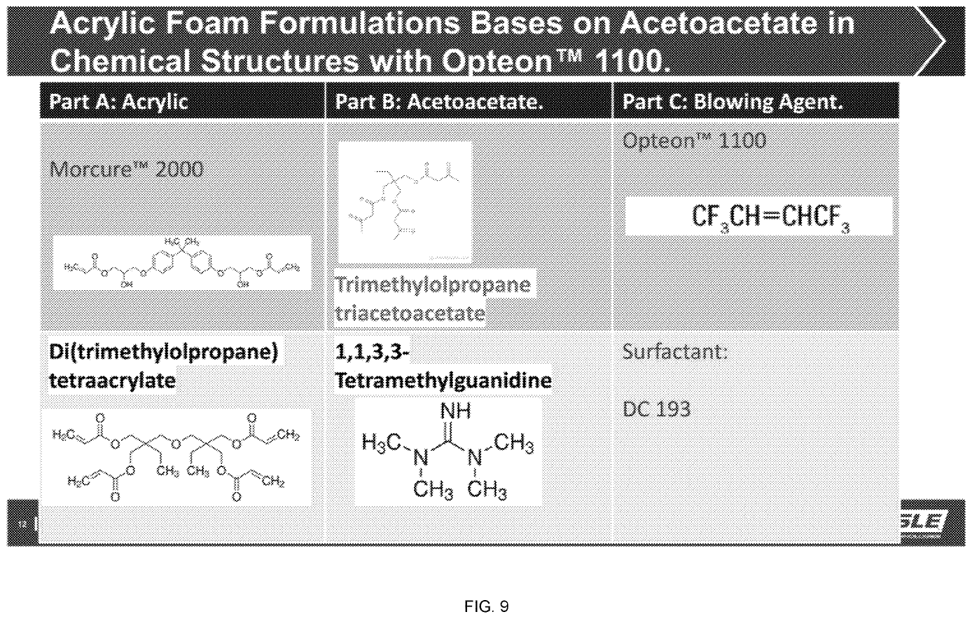

FIG. 9 shows pentane as the blowing agent and Elkem 3230 as the silicone prepolymer. The density was reduced from 172 kg/m3 to 146 kg/m3 when 5% blowing agent was used versus 10%. Also, the cell structure changed from close-cell to open-cell.

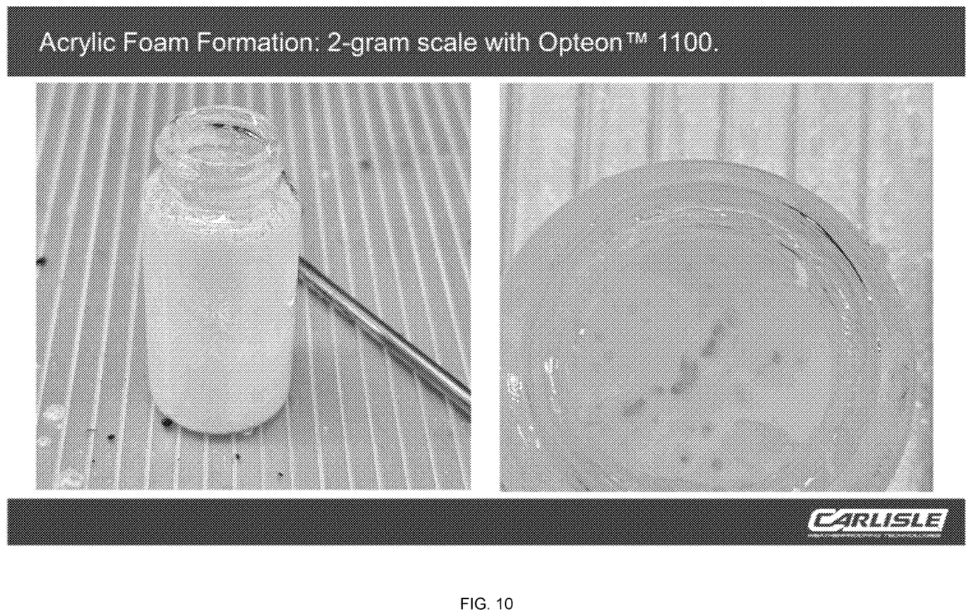

FIG. 10 shows cyclopentane as blowing agent and Elkem 3230 as the silicone prepolymer with the cyclopentane loadings of 0%, 5%, and 10%. Density increased back at a higher 10% loading of the cyclopentane.

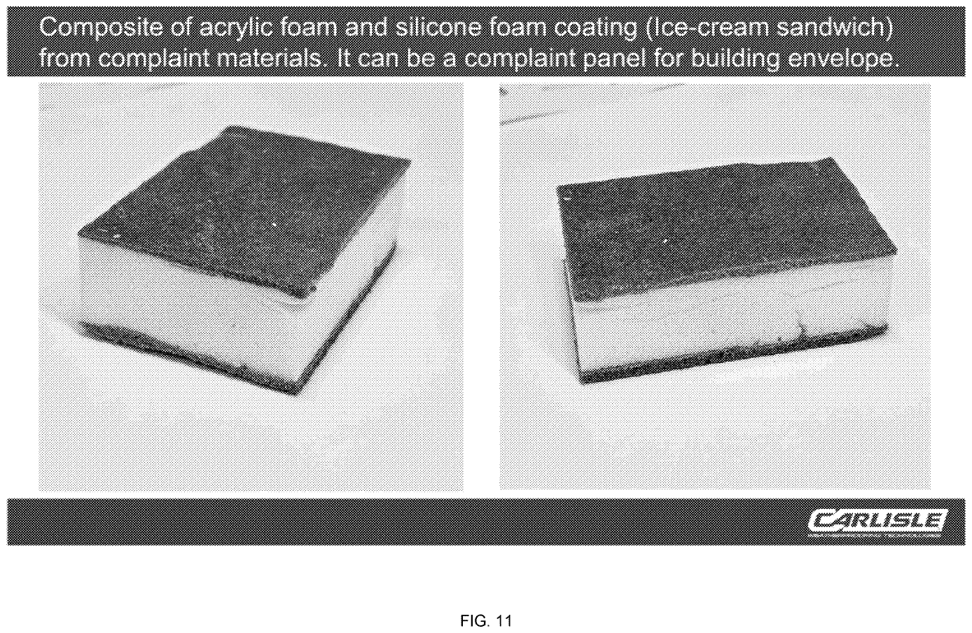

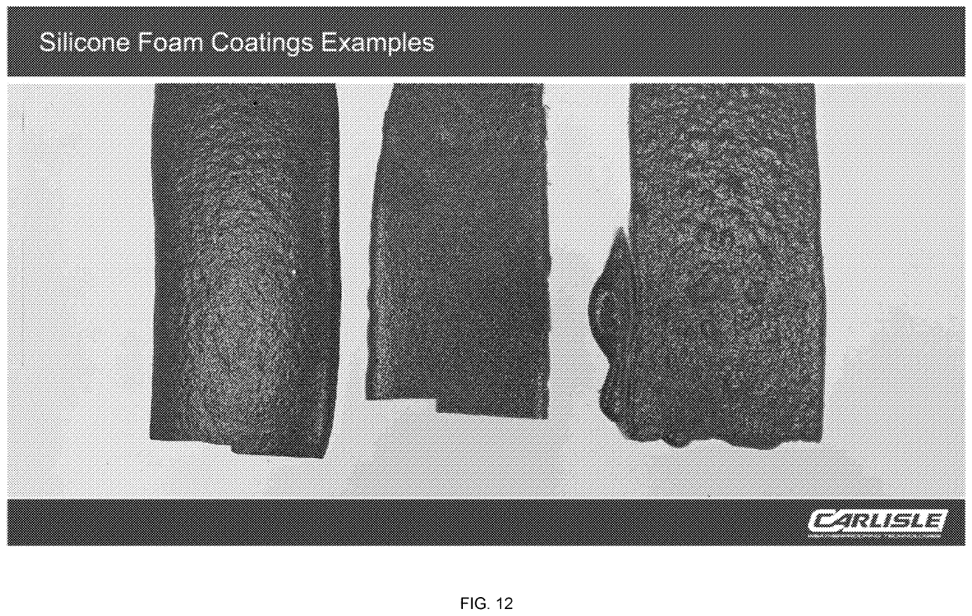

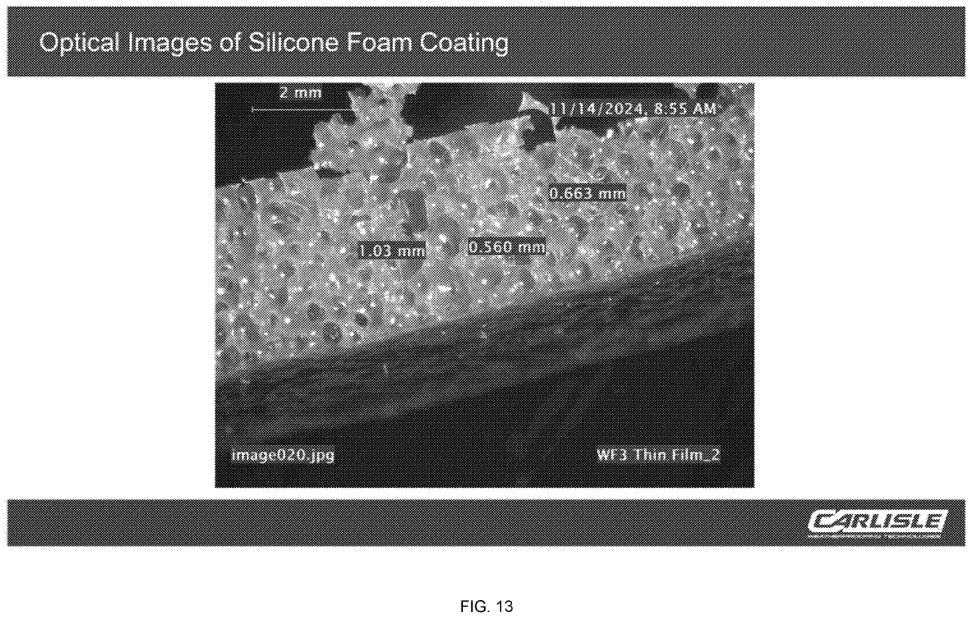

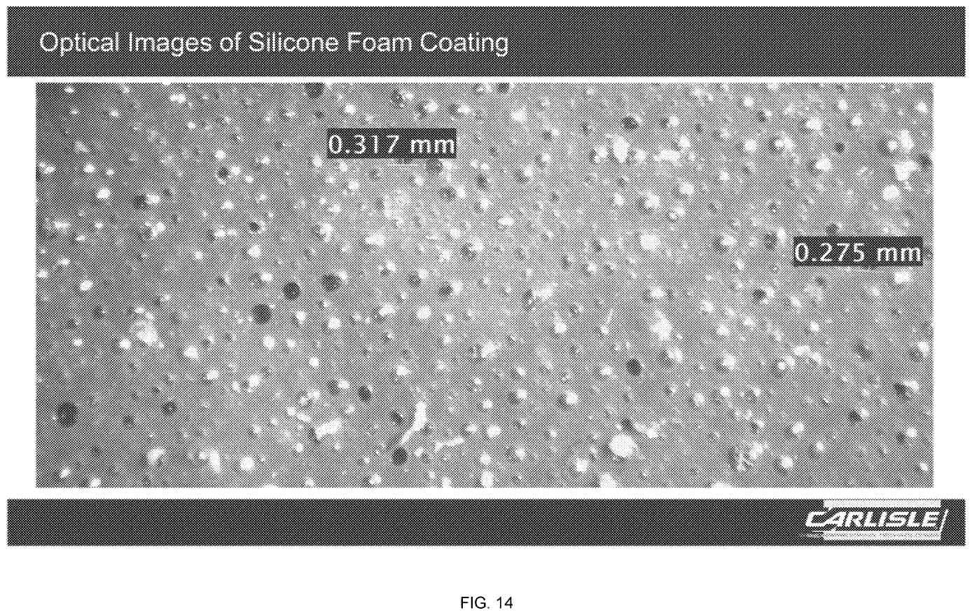

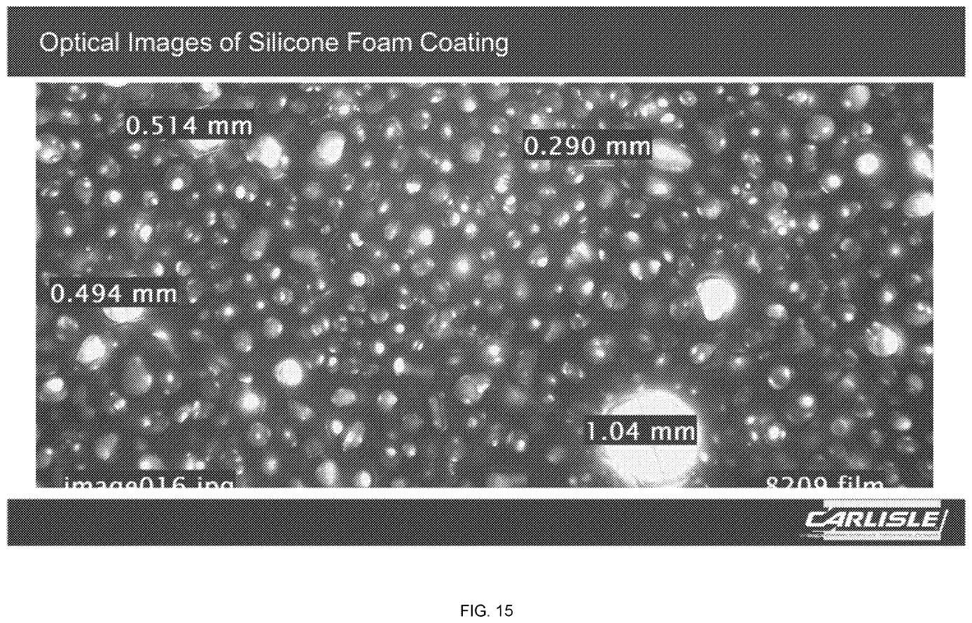

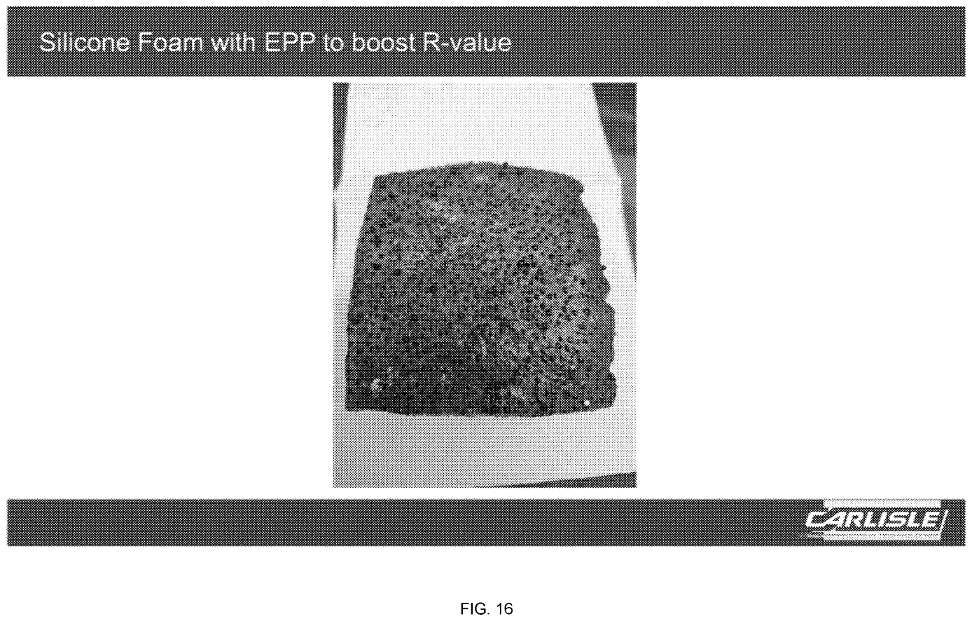

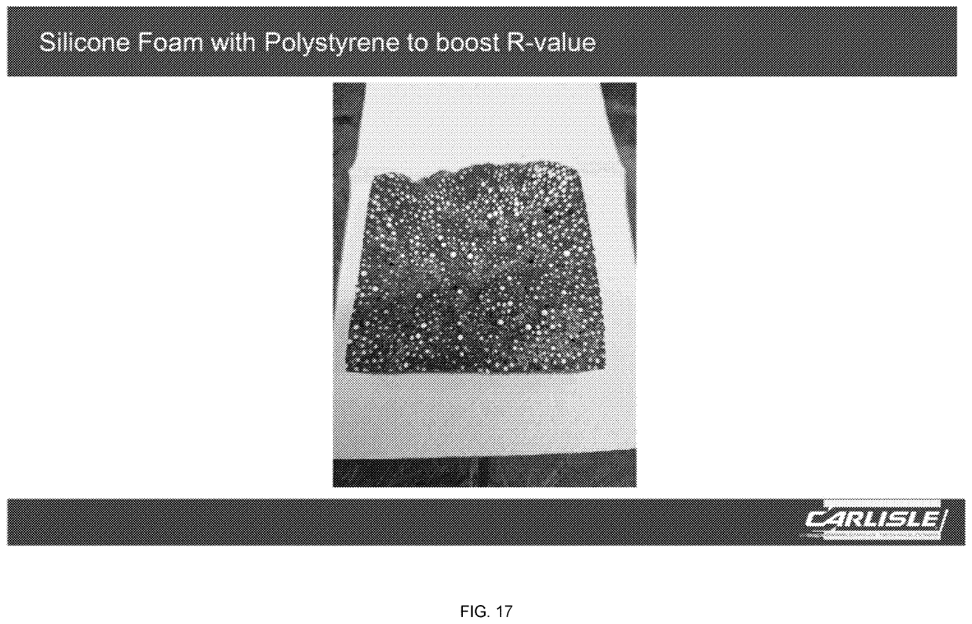

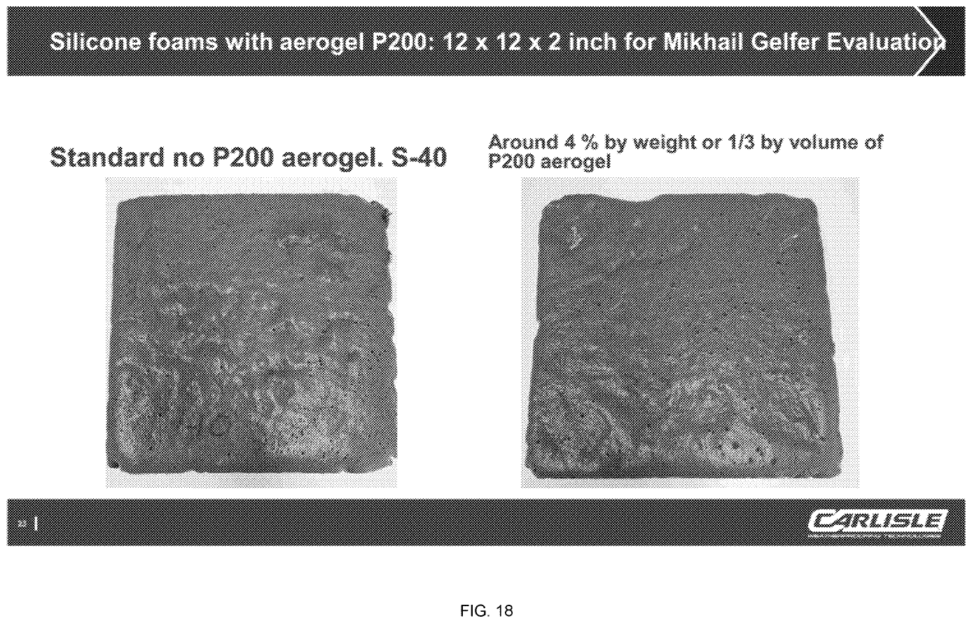

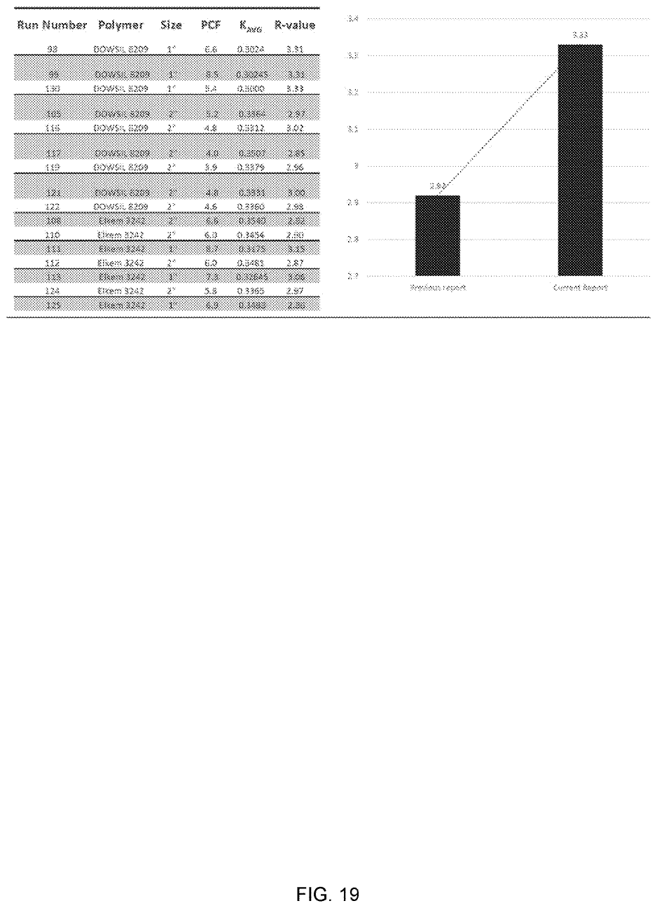

As shown in FIG. 11, when Opteon™1100 was used as the blowing agent with the Elkem 3230 silicone prepolymer, and Dow prepolymers, the samples did not cure after a long time. For example, the foams with 10% and even 1% of loading of Opteon® 1100 are still not cured after 3 weeks. Without wishing to be bound by theory, we surmise that this fluorinated blowing agent retards the formation of the silicone foams by deactivation of the catalysts, Si—H abstraction or hydrosilylation reaction on carbon-carbon double bond.

In conclusion, the present invention relates to a non-requirement of isocyanate in preparing foams, because they are silicone foams. Also, the application of the blowing agents based on the thermal expansion mechanism resulted in the decrease of density of the foams up to 50%. In one embodiment, the numerical density of the resultant foams was found to be close to commercial low-density silicone foams between 100 to 150 kg/m³. In one embodiment, the order of blowing agents was found as the following:
Methylal>Methyl Formate>Pentane>Cyclopentane>>Opteon™ 1100.

In one embodiment, chemically activated blowing agents are also considered in the process described above.

Accordingly, in one aspect, the present invention provides a silicone foam for use in insulating an exterior surface of a building, wherein said silicone foam has an open-cell structure, and preferably has a foamed density of between 50-350 Kg/m³.

Preferably, the open cell structure of the foams of the present invention have a structure wherein the cells are essentially open but include some randomly occurring, solid cell walls.

In one embodiment, the open cell structure of the foams of the present invention is formed by a combination of surfactants that results in a surfactant interaction which produces both completely open and at least partially open, cell walls. In one embodiment, if measured by a method such as ASTM D6226, the open cell content of the foams of the present invention is preferably greater than 80%, and more preferably, greater than 80%.

The size of the cell can vary depending on the materials used, and the amount of blowing agent, and the like, which is used. Preferably, the foams of the present invention have a cell size of between 0.03 μm, and 1.5 μm, and more preferably between 0.1 μm and 1.0 μm.

The insulating ability (for example the “R” value) of the foam is preferably such that the silicone foam of the present invention will provide an R value of between 2 and 20 per inch of thickness. As such, typical “R” values would be between the ranges of 4 and 12 for a 2-inch thickness foam.

In an exemplary implementation of the present invention, a first silicone pre-polymer (Component A) is mixed with a second silicone pre-polymer (Component B), at room temperature or under heat, so that the two components react and foam. Preferably, the two components are mixed in the spray nozzle of a spray gun.

In another aspect, the present invention provides a semi-rigid, silicone foam, for use in insulating an exterior surface of a building, wherein said sprayed silicone foam has an open cell structure and density, as previously described with respect to the present invention.

In another aspect, the present invention provides a method for insulating the exterior surface of a building comprising spraying the exterior surface of the building with the foamed reaction mixture of one or more silicone pre-polymers in order to produce a silicone foam having an open cell structure and density, as previously described with respect to the present invention.

The general production methods to produce silicone foams are well known to the skilled artisan, as is the general chemistry for production thereof. As such, these will not be described in any specific detail.

The nature, types and amounts of blowing agents which are used in silicone foam manufacture are well known to those skilled in the art, but can include, for example, water, carbon dioxide, hydrofluorocarbons (HFCs), chlorinated fluorocarbons, hydrofluro olefins (HFOs), and the like.

In contrast, for the present invention, non-fluorinated blowing agent is the preferred blowing agent for formulations of the present invention. In the formulations used for preparing the silicone foams of the present invention, the non-fluorinated blowing agent will be present at a concentration of from 0.5 to 40 weight percentage of B-side component.

Alternatively, other blowing agents can be used, or combined with the non-fluorinated blowing agents such as methylal, in order to generate a gaseous material during the curing reaction. While carbon dioxide is a preferred gas for generation, other gases such as hydrogen, nitrogen, pentane, and fluorinated blowing agents such as HFOs, HFCs, or the like, may be released, or directly used, in order to form a foam with the desired density and cell shape and size.

The total amount and type of blowing agent is selected however, so as to provide a silicone foam having the desired density range.

The silicone foam material of use in the present invention can also be custom formulated and engineered for specific applications. The range of formulations includes using rigid, semi-rigid, or more preferably semi-flexible or flexible, silicone foams that may include a range of organic and inorganic reinforcing materials which may be in the form of a particle or fiber with the said reinforcing materials being in a variety of densities, sizes and regular and irregular shapes.

Additionally, other additives such as catalysts or surfactants, or the like, can be added to the reaction mixture in order to control various properties of the silicone foam.

Surfactants are also preferably included to provide the proper cell structure, and these are silicone based. However, any suitable surfactants might be used. By introducing surfactants, the foam materials can be caused to make more cells, and by proper selection of surfactants, the preferred combination of open and partially-closed cell configurations of the present invention can be achieved.

Preferred surfactants include combinations of cell opening-promoting surfactants like Evonik TEGOSTAB B8523, B8580, B84710, B8870, Ortegol 204, Ortegol 500, and Ortegol 501, and closed cell-promoting surfactants like Evonik TEGOSTAB B8408, B8453, and B8487.

Preferably, the systems of the present invention include combinations of these types of surfactants to produce open cells have some randomly occurring, solid cell walls.

The total amount of surfactants present is preferably between 0.1 and 10% by weight of the B-side component, and more preferably, between 1 and 6%, by weight. Most preferably, the weight of the surfactant is between 2 and 4% by weight of the B-side component.

The mixture of open cell and closed cell promoting surfactants, in the total surfactant added, is preferably such that the open cell promoting surfactant accounts for between 10 to 90% by weight of the surfactant mixture.

The amount and ratio of the surfactant types is selected to provide the desired cell size, foam density, and amount of essentially open cells with some cells including some randomly occurring, solid cell walls.

Where uniformity of cell structure is required, fine organic or inorganic particles in a size range between 50 and 500 microns, may be added.

Other materials can be included in the formulations of the present invention. For example, coupling agents, such as silane or titanates, may also be included in the preparation of the composition to improve the physical properties of the material. Where other properties are desired, additional additives may be added to the composition including colorants, dry or liquid inks or pigments, fire and flame retardants, UV absorbers and protectants, antistatic agents, and such other additives as required, and which are known within the industry.

Silicone foam generally denotes a polyorganosiloxane composition in the foam form. Silicone foams preparation is described in several patents. However, the present invention uses non-fluorinated blowing agents to make the silicone foams.

With regard to silicone foams, several techniques exist for producing them. A first technique employs a condensation reaction with release of volatile by-products. This is the case in particular for systems using the condensation reaction of the SiH—SiOH type, which makes it possible to release hydrogen which then acts as a porogenic agent. For example, French patent No. FR-A-2 589 872 describes a silicone foam precursor composition comprising an organosilicon polymer comprising siloxane units having hydroxyl groups bonded to the silicon, an organosilicon polymer comprising siloxane units having hydrogen atoms bonded to the silicon, a catalyst, for example a tin compound, and a finely divided filler comprising silica which has been treated to become hydrophobic.

A variant described in U.S. Pat. No. 3,923,705 consisted in providing compositions comprising polydiorganosiloxanes bearing hydrogen atoms bonded to the silicon available for a condensation reaction with polydiorganosiloxanes bearing hydroxyl groups bonded to the silicon (silanols) in the presence of a platinum catalyst. This reaction thus makes it possible to construct the network while producing hydrogen gas necessary for the formation of a silicone foam. In this type of formulation, the formation of gas is proportional to the rate of crosslinking and consequently the density of the foams obtained is difficult to control, thus explaining the difficulties in obtaining low-density foams by this technique.

According to another variant described in U.S. Pat. No. 4,189,545, silicone foams are prepared from a composition comprising water, a polydiorganosiloxane bearing vinyl groups bonded to the silicon, a polydiorganosiloxane containing hydrogen atoms bonded to the silicon and borne by units in the chain and not exclusively at the chain end, in order to be able to act as a crosslinking agent. The water reacts with the polysiloxane comprising hydride functions, thus producing hydrogen gas and a silanol. The silanol then reacts with the polydiorganosiloxane comprising hydride functions via a condensation reaction, thus generating a second molecule of hydrogen gas, while another polydiorganosiloxane bearing vinyl groups bonded to the silicon will simultaneously react, via an addition reaction, with another polydiorganosiloxane comprising a hydride function, thus participating in the construction of the network of the silicone foam.

In U.S. Pat. No. 4,590,222, silicone foams are prepared from a composition comprising a polydiorganosiloxane, a resin, a platinum-based catalyst, an organohydro-siloxane, a polyorganosiloxane bearing hydroxyl groups on the chain-end units, a filler and an organic alcohol.

### B. Acrylic Foams

As used herein, “(meth)acrylate” means acrylate or methacrylate, and “(meth)acrylic” means acrylic or methacrylic. The present invention involves the use of compounds with functional groups capable of undergoing a Michael addition reaction. Michael addition is taught, for example, by RT Morrison and RN Boyd in Organic Chemistry, third edition, Allyn and Bacon, 1973. The reaction is believed to take place between a Michael donor and a Michael acceptor, in the presence of a strong base catalyst.

A “Michael donor,” as used herein, is a compound with at least one Michael donor functional group, which isa functional group containing at least one Michael active hydrogen atom, which is a hydrogen atom attached to a carbon atom that is located between two electron-withdrawing groups such as C—O and/or C═N. Examples of Michael donor functional groups are malonate esters, acetoacetate esters, malonamides, and acetoacetamides (in which the Michael active hydrogens are attached to the carbon atom between two carbonyl groups); and cyanoacetate esters and cyanoacetamides (in which the Michael active hydrogens are attached to the carbon atom between the carbonyl group and the cyano group). A compound with two or more Michael active hydrogen atoms is known herein as a multifunctional Michael donor. A Michael donor may have one, two, three, or more separate functional groups that each contain one or more Michael active hydrogen atoms. The total number of Michael active hydrogen atoms on the molecule is the functionality of the Michael donor. As used herein, the “skeleton” of the Michael donor is the portion of the donor molecule other than the functional group containing the Michael active hydrogen atom(s).

A “Michael acceptor,” as used herein, is a compound with at least one functional group with the structure (I)R1R2C═C□C(O)R3-, where R1, R2, and R3 are, independently, hydrogen or organic radicals such as for example, alkyl(linear, branched, or cyclic), aryl, alkaryl, including derivatives and substituted versions thereof. R1, R2, and R3 may or may not, independently, contain ether linkages, carboxyl groups, further carbonyl groups, thio analogs thereof, nitrogen containing groups, or combinations thereof. A compound with two or more functional groups, each containing structure (I), is known herein as a multi-functional Michael acceptor. The number of functional groups containing structure (I) on the molecule is the functionality of the Michael acceptor. As used herein, the “skeleton” of the Michael acceptor is the portion of the donor molecule other than structure (I). Any structure (I) may be attached to another (I) group or to the skeleton directly.

In the practice of the present invention, the skeleton of the multi-functional Michael acceptor may be the same or different from the skeleton of the multi-functional Michael donor. In some embodiments, one or more polyhydric alcohol is used as at least one skeleton. Some polyhydric alcohols suitable as skeletons for the multi-functional Michael acceptor include, for example, alkane diols, alkylene glycols, glycerols, sugars, pentaerythritols, polyhydric derivatives thereof, or mixtures thereof. Some polyhydric alcohols suitable as skeletons include, for example, cyclohexane dimethanol, hexane diol, castor oil, trimethylol propane, glycerol, ethylene glycol, propylene glycol, pentaerythritol, neopentyl glycol, diethylene glycol, dipropylene glycol, butanediol, 2-methyl-1,3-propanediol, trimethylolethane, similar polyhydric alcohols, substituted versions thereof, and mixtures thereof.

Further examples of polyhydric alcohols suitable as skeletons in multi-functional Michael acceptor include, for example, polyhydric alcohols with molecular weight of 150 or greater (in addition to those named herein above). One suitable polyhydric alcohol with molecular weight of 150 or greater is 4,8-Bis(hydroxymethyl)tricyclo[5.2.1.0^{2,6}]decane, Chemical Abstracts Service (CAS) registry number 26896-48-0; any isomers or mixtures thereof are suitable. Another suitable polyhydric alcohol with molecular weight of 150 or greater is Polysorbate 80, CAS registry number 9005-65-6. Further examples of polyhydric alcohols with molecular weight of 150 or greater suitable as skeletons include, for example, polyethylene glycol, polypropylene glycol, glucose, and dipentaerythritol. Additionally, a wide variety of fatty acids and related oils are either polyhydric alcohols or may be hydroxylated by a variety of methods to form polyhydric alcohols; such polyhydric alcohols are also suitable. Some examples of fatty acids and related oils suitable as skeletons in the present invention are castor oil, hydroxylated fats and oils, hydroxylated derivatives of fats and oils, and mixtures thereof. Polyhydric alcohols similar to those named above are also suitable as skeletons. Also, mixtures of suitable polyhydric alcohols are suitable.

In some embodiments, the skeleton of the multi-functional Michael acceptor is an oligomer or a polymer. A polymer, as used herein and as defined by F. W. Billmeyer, J R. in Textbook of Polymer Science, second edition, 1971 (“Billmeyer”) is a relatively large molecule made up of the reaction products of smaller chemical repeat units. Normally, polymers have 11 or more repeat units. Polymers may have structures that are linear, branched, star shaped, looped, hyperbranched, or crosslinked; polymers may have a single type of repeat unit (“homopolymers”), or they may have more than one type of repeat unit (“copolymers”). As used herein, “resin” is synonymous with polymer.

Polymers have relatively high molecular weights. Polymer molecular weights can be measured by standard methods such as, for example, size exclusion chromatography or intrinsic viscosity. Generally, polymers have weight-average molecular weight (Mw) of 1,000 or more. Polymers may have extremely high Mw; some polymers have Mw above 1,000,000; typical polymers have Mw of 1,000,000 or less.

“Oligomers,” as used herein, are structures similar to polymers except that oligomers have fewer repeat units and lower molecular weight. Normally, oligomers have 2 to 10 repeat units. Generally, oligomers have Mw of 400 to 1,000.

In some embodiments, oligomers and/or polymers may be used as one or more skeleton. One reason for using oligomers and/or polymers as one or more skeleton is to provide the functional mixture with the desired viscosity. Also, in embodiments in which the functional mixture will be used as an adhesive, oligomers and/or polymers are believed to improve the green strength of the adhesive (that is, the adhesive strength obtained before the cure reactions are complete).

The European Patent No. EP 1 435 383 A1 is incorporated in its entirety by reference herein. Similarly, the PCT Patent Application PCT/EP2023/079625 and its corresponding publication No. W) 2024/089026 is also incorporated by reference herein.

Polymers have relatively high molecular weights. Polymer molecular weights can be measured by standard methods such as, for example, size exclusion chromatography or intrinsic viscosity. Generally, polymers have weight average molecular weight (Mw) of 1,000 or more. Polymers may have extremely high Mw; some polymers have Mw above 1,000,000; typical polymers have Mw of 1,000,000 or less. “Oligomers,” as used herein, are structures similar to polymers except that oligomers have fewer repeat units and lower molecular weight. Normally, oligomers have 2 to 10 repeat units. Generally, oligomers have Mw of 400 to 1,000. The practice of the present invention involves formation of a functional mixture that includes at least one multifunctional Michael donor, at least one multi-functional Michael acceptor, and at least one strong base catalyst. In some embodiments, the functional mixture of the present invention may also contain one or more adjuvants chosen to improve the properties, such as, for example, solvents, tackifiers, emulsifiers, polymers, plasticizers, blowing agents, expandable microspheres, thickeners, or reactive compounds that are neither multi-functional Michael donors nor multi-functional Michael acceptors. Adjuvants are preferably chosen to be compatible with the functional mixture and used in a way that does not interfere with the practice of the invention (for example, adjuvants will preferably be chosen that do not interfere with the mixing of the ingredients, the cure of mixture, the application to substrate, or the final properties of the cured mixture).

Some suitable multi-functional Michael acceptors in the present invention include, for example, molecules in which some or all of the structures (I) are residues of (meth)acrylic acid, (meth)acrylamide, fumaric acid, or maleic acid, substituted versions thereof, or combinations thereof, attached to the multi-functional Michael acceptor molecule through an ester linkage. A compound with structures (1) that include two or more residues of (meth)acrylic acid attached to the compound with an ester linkage is called herein a “poly-functional (meth)acrylate.” Poly-functional (meth)acrylates with at least two double bonds capable of acting as the acceptor in Michael addition are suitable multi-functional Michael acceptors in the present invention. Preferred poly-functional (meth)acrylates are poly-functional acrylates (compounds with two or more residues of acrylic acid, attached with an ester linkage). Examples of suitable multi-functional Michael acceptors that are poly-functional acrylates include 1,4-butanedioldiacrylate, 1,6-hexanediol diacrylate, neopentyl glycol diacrylate, diethylene glycol diacrylate, triethylene glycol diacrylate, tetraethylene glycol diacrylate, polyethylene glycol diacrylate, dipropylene glycol diacrylate, tripropylene glycol diacrylate, cyclohexane dimethanol diacrylate, alkoxylated hexanediol diacrylate, alkoxylated cyclohexanedimethanol diacrylate, propoxylated neopentyl glycol diacrylate, trimethylolpropane triacrylate, ethoxylated trimethylolpropane triacrylate, propoxylated trimethylolpropane triacrylate, acrylated polyester oligomer, bisphenol A diacrylate, ethoxylated bisphenol A diacrylate, tris(2-hydroxyethyl) isocyanurate triacrylate, acrylated aliphatic urethane oligomer, acrylated aromatic urethane oligomer, and the like, and mixtures thereof.

Also suitable as the multi-functional Michael acceptor are poly-functional (meth)acrylates in which the skeleton is polymeric. The (meth)acrylate groups may be attached to the polymeric skeleton in any of a wide variety of ways. For example, a (meth)acrylate ester monomer may be attached to a polymerizable functional group through the ester linkage, and that polymerizable functional group may be polymerized with other monomers in a way that leaves the double bond of the (meth)acrylate group intact. For another example, a polymer may be made with functional groups.
(such as, for example, a polyester with residual hydroxyls), which may be reacted with a (meth)acrylate ester (for example, by transesterification), to yield a polymer with pendant (meth)acrylate groups. For yet another example, a homopolymer or copolymer may be made that includes a poly-functional acrylate monomer (such as trimethylol propane triacrylate) in such a way that not all the acrylate groups react. In embodiments in which the skeleton of the multifunctional Michael acceptor is a polymer, the functional groups (I) may be pendent from the polymer chain, or they may be incorporated into the polymer chain, or a combination thereof.

Also among suitable multi-functional Michael acceptors are compounds with two or more functional groups each containing structure (I) in which one or more of the functional groups containing structure (I) is the residue of (meth)acrylamide. That is, one or more of the functional groups containing structure (I) is:

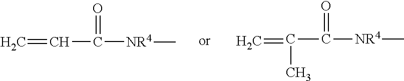

where R4 is defined in the same way as R1, R2, and R3, defined herein above; all of R1, R2, R3, and R4 may be chosen independently of each other. In some suitable multi-functional Michael acceptors, all the functional groups containing structure (I) are residues of (meth)acrylamide (including, for example, methylene bisacrylamide). In other suitable multifunctional Michael acceptors, at least one functional group containing structure (I) is a residue of (meth)acrylamide, and at least one functional group containing structure (I) is a functional group other than a residue of (meth)acrylamide.

Mixtures of suitable multi-functional Michael acceptors are also suitable.

The practice of the present invention involves the use of a multi-functional Michael donor. In some embodiments of the present invention, the skeleton of the multi-functional Michael donor is the residue of a polyhydric alcohol, such as, for example, those listed herein above. In some embodiments, the skeleton of the multi-functional Michael donor may be a polymer, such as for example, a poly alkylene oxide, a polyurethane, a polyethylene vinyl acetate, a polyvinyl alcohol, a polydiene, a hydrogenated polydiene, an alkyd, an alkyd polyester, a polyolefin, a halogenated polyolefin, a polyester, a halogenated polyester, a (meth)acrylate polymer, a copolymer thereof, or a mixture thereof. In embodiments in which the skeleton of a multi-functional Michael donor is a polymer, the Michael donor functional group may be pendant from the polymer chain, or it may be incorporated into the polymer chain, or a combination thereof.

Some suitable multi-functional Michael donors include, for example, malonic acid, acetoacetic acid, amides of malonic acid, amides of acetoacetic acid, alkyl esters of malonic acid, and alkyl esters of acetoacetic acid, where the alkyl groups may be linear, branched, cyclic, or a combination thereof. Other suitable multi-functional Michael donors include polyhydric alcohols in which one or more hydroxyl group is linked to an acetoacetate group through an ester linkage. Some suitable multi-functional Michael donors are, for example, methyl acetoacetate, ethyl acetoacetate, t-butyl acetoacetate, other alkyl acetoacetates, 2-acetoacetoxyethyl (meth)acrylate, butane diol diacetoacetate, 1,6-hexanediol diacetoacetate, neopentylglycol diacetoacetate, the diacetoacetate of 4,8-Bis(hydroxymethyl)tricyclo[5.2.1.02,6]decane, 2-methyl-1,3-propanediol diacetoacetate, diethylene glycol diacetoacetate, ethylene glycol diacetoacetate, propylene glycol diacetoacetate, dipropylene glycol diacetoacetate, polyethylene glycol diacetoacetate, polypropylene glycol diacetoacetate, cyclohexanedimethanol diacetoacetate, other diol diacetoacetates, trimethylolpropane triacetoacetate, pentaerythritol triacetoacetate, glycerol trisacetoacetate, trimethylolethane triacetoacetate, other triol triacetoacetates, diacetoacetates of triols, analogous malonate esters, and the like. Some further examples of suitable multi-functional Michael donors include tetra-, penta-, and higher acetoacetates of polyols (i.e., polyols on which four, five, or more hydroxyl groups are linked to acetoacetate groups through ester linkages), including, for example, pentaerythritol tetraacetoacetate, glucose tetraacetoacetate, glucose pentaacetoacetate, dipentaerythritol pentaacetoacetate, and dipentaerythritol hexaacetoacetate. Additional suitable multi-functional Michael donors include compounds with one or more of the following functional groups: acetoacetate, acetoacetamide, cyanoacetate, and cyanoacetamide; in which the functional groups maybe attached to one or more of the following skeletons: castor oil, polyester polymer, polyether polymer, (meth)acrylicpolymer, polydiene polymer. Some suitable multi-functional Michael donors are, for example, acetoacetate functional castor oil, acetoacetate functional polyester polymer, acetoacetate functional polyesteramide polymer, acetoacetamide functional polyether polymer, acetoacetate functional (meth)acrylic polymer, cyanoacetamide functional (meth)acrylic polymer, cyanoacetate functional (meth)acrylic polymer, acetoacetate functional polybutadiene polymer.

Some preferred multi-functional Michael donors are multifunctional acetoacetate functional polyester polymers and acetoacetate functional polyesteramide polymers. Acetoacetate functional polyester polymers may be made by any available method; one method, for example, is a two-step process. In the first step, one or more polyhydric alcohol such as a diol or triol is condensed with one or more di- or tricarboxylic acids to form a polyester terminated with hydroxy radicals. In the second step, the polyester is reacted with an acetoacetate compound such as, for example, an alkyl acetoacetate with an alkyl group with 1 to 4 carbon atoms. Similarly, Acetoacetate functional polyesteramide polymers may be made by any available method; one method, for example, is a two-step process. In the first step, one or more polyhydric alcohol such as a diol or triol, including at least one amino alcohol, is condensed with one or more di- or tricarboxylic acids to form a polyesteramide terminated with hydroxy radicals. In the second step, the polyesteramide is reacted with an acetoacetate compound such as, for example, an alkyl acetoacetate with an alkyl group with 1 to 4 carbon atoms.

Mixtures of suitable multi-functional Michael donors are also suitable.

The practice of the present invention involves the use of a strong base catalyst. A “strong base catalyst,” as used herein, is a compound that will catalyze a Michael addition reaction. While the invention is not limited to any specific theory, it is believed that the strong base catalyst abstracts a hydrogen ion from the Michael donor. Some compounds that are known to function as strong base catalysts are, for example, certain amine compounds, ammonium compounds, acetylacetonate compounds, hydroxides, alkoxides, and compounds that have anions derived from acetoacetate groups. Among the suitable amine compounds are, for example, piperidine and amidine compounds. Among the hydroxide compounds suitable as the strong base catalyst are, for example, sodium hydroxide and potassium hydroxide. Among the alkoxides suitable as the strong base catalyst are, for example, sodium alkoxides and potassium alkoxides such as, for example, sodium methoxide, sodium ethoxide, sodium propoxide, sodium butoxide, potassium methoxide, potassium ethoxide, potassium propoxide, and potassium butoxide.

Also suitable as strong base catalysts are compounds similar to those listed above. Also suitable are mixtures of suitable strong base catalysts. Preferred strong base catalysts are sodium alkoxides and potassium alkoxides; more preferred is sodium ethoxide.

Polymeric foams may be made in a variety of ways. Some foams are made by lowering external pressure (extrusion, compression molding, and injection molding, for example); others by creating increased pressure within cells (expandable formulations); still others by dispersing gas in the polymer (froth methods); and still others by sintering polymer particles in a way that traps cells. In some expandable formulations, gas pressure within cells may be created by decomposition of a blowing agent, which is a chemical that releases gas when exposed to high temperatures. In other expandable formulations, gas pressure within cells may be created by release of gas from expandable microspheres, such as, for example, Expancel™ microspheres from Akzo Nobel Company, which release gas when heated.

In one embodiment of the present invention, a suitable functional mixture is made that includes suitable expandable microspheres. The functional mixture is made in or transferred into a suitable mold or other container. The functional mixture is then heated; the expandable microspheres release gas to form the cells, and the Michael addition reaction cures to form a polymer mass that has the cells dispersed within.

Morcure™ 2000 as used herein is diacrylate of diglycidyl ether bisphenol-A, from Rohm and Haas Co.

In one embodiment, the acrylic foams based on 1,1,1-trimethylpropane trisacetoacetate (AcAc) are made.

In another embodiment, silicone foams comprising expanded PP (ePP) and expanded PS (ePS).

The practice of the present invention involves formation of a functional mixture that includes at least one multi-functional Michael donor, at least one multi-functional Michael acceptor, and at least one strong base catalyst. In some embodiments, the functional mixture of the present invention may also contain one or more adjuvants chosen to improve the properties, such as, for example, solvents, tackifiers, emulsifiers, polymers, plasticizers, blowing agents, expandable microspheres, thickeners, or reactive compounds that are neither multi-functional Michael donors nor multi-functional Michael acceptors. Adjuvants are preferably chosen to be compatible with the functional mixture and used in a way that does not interfere with the practice of the invention (for example, adjuvants will preferably be chosen that do not interfere with the mixing of the ingredients, the cure of mixture, the application to substrate, or the final properties of the cured mixture).

In other expandable formulations, gas pressure within cells may be created by release of gas from expandable microspheres, such as, for example, Expancel™ microspheres from Akzo Nobel Company, which release gas when heated.

In one embodiment of the present invention, a suitable functional mixture is made that includes suitable expandable microspheres. The functional mixture is made in or transferred into a suitable mold or other container. The functional mixture is then heated; the expandable microspheres release gas to form the cells, and the Michael addition reaction cures to form a polymer mass that has the cells dispersed within.

Expanded polypropylene (EPP) has a low density and it has a high elasticity; it has low compressibility and a high deformation recovery rate. EPP is resistant to oils, acid and alkali chemicals, and solvents; it does not readily absorb water. In addition to being non-toxic and tasteless, it can be recycled with very high efficiency with minimal performance degradation.

EPP is used in similar applications as EPS, including packing material, insulation, and safety gear. EPP can be used to make microwaveable food containers and is heat resistant. EPP is more elastic and less brittle than EPS, which is easily dented permanently, while EPP springs back into shape. EPS tends to crack, snap or crumble under stress, making it unsuitable for items that must withstand multiple impacts such as automotive bumpers. EPP, on the other hand, is used extensively in the automobile industry. Unlike EPS, EPP can be used for furnishings. It is more fire resistant than EPS and can be used for exposed surfaces, whereas EPS building insulation must be covered with Sheetrock or a similar nonflammable material.

Expanded Polystyrene (EPS) Properties is a lightweight material is easy to mold and cut. Therefore, it can be used in various products design. EPS is regularly found in packaging, insulation, large blocks, insulated containers, etc.

Expanded polystyrene has great insulation properties. This is why it is used in food industry for longer food preservation. It also serves a lot in the medical field: EPS can maintain the right temperature and thus ensure the medical supplies are optimal. On the other hand, this material is used to protect many objects during transportation, handling and storage. You will notice, when buying furniture, appliances or other items, that most of them are protected with EPS designed corners. It is also possible to find expanded polystyrene in insulation products. Indeed, different insulation products are manufactured to meet industrial, residential, commercial and institutional sectors requirements. They can be used in new constructions or during renovations. The use of these materials ensures a permanent insulating value, guarantees a better quality-price ratio, and facilitates installation.

### Experimental 2

The average density of acrylic foam was found to be 2.67 pcf.

R-value of the baseline silicone foams with R around 3. Cartersville also shown improvement in R-value from 2.92 from the previous round of measurement to 3.33.

12×12×1 Samples of silicone foams with Cabot 200 aerogel from Michael Gelfer were prepared.

Acrylic foams based on trimethylolpropane cyanoacetate are prepared.

In one embodiment, flame-retardants are incorporated into acrylic foams.

Dowsil 8209 and Elkem 3242 were used to prepare silicone foams.

Dowsil 3-8209 is a two-part, room temperature silicone foam system designed to be dispensed and cured directly on parts to form an integrated compression gasket. It is low to medium hardness product, primarily developed as a dispensed ‘foamed-in-place’ gasket material for the automotive and industrial assembly and maintenance industries. Dowsil 3-8209 was obtained from Dow Chemical Co. in Midland, Michigan.

Elkem 3242 is a silicone material obtained from the Elkem company in York, South Carolina.

Blowing agents that can be sued for silicone include Water, alcohols, diols, and glycerol. Examples include water, nitrogen, carbon dioxide, isopentane, and n-butane, Azodicarbonamide, trinitroso-trimethylene triamine, DPSDSH, p,p-oxydi(benzenesulfonyl semicarbazide), sodium bicarbonate, sodium citrate, melaniline, oxalic acid, pentaerythritol, and zinc oxide. Blowing agents are discussed in US20240166869A1 which is incorporated by reference herein.

What is claimed:

1. A composite foam sandwich comprising:
(i) at least one foam comprising predominantly silicone, designated as As; and
(ii) at least one foam predominantly comprising acrylic, designated as Bs.

2. A composite foam sandwich as recited in claim 1, wherein the structure is expressed as follows:
(AiBj)n, wherein:
A designates a foam predominantly comprising silicone;
B designates a foam predominantly comprising acrylic;
i=0-5; j=0-5; and n=1-10.

3. The composite foam sandwich as recited in claim 1, comprising one of the following structures:
A1/B1; A1/B1/A2; B1/A1/B2; A1/B1/B2; A1/A2/B1; and A1/A2/B1/B2.

4. The composite foam sandwich as recited in claim 1, wherein the foam comprising predominantly acrylic comprises reaction product of a reaction mixture comprising:
(a) at least one multi-functional Michael donor;
(b) at least one multi-functional Michael acceptor; and
(c) at least one base catalyst.

5. The foam sandwich as recited in claim 4, wherein:
(a) the multi-functional Michael donor is selected from methyl acetoacetate, ethyl acetoacetate, t-butyl acetoacetate, other alkyl acetoacetates, 2-acetoacetoxyethyl (meth)acrylate, butane diol diacetoacetate, 1,6-hexanediol diacetoacetate, neopentylglycol diacetoacetate, the diacetoacetate of 4,8-Bis(hydroxymethyl)tricyclo[5.2.1.0]decane, 2-methyl-1,3-propanediol diacetoacetate, diethylene glycol diacetoacetate, ethylene glycol diacetoacetate, propylene glycol diacetoacetate, dipropylene glycol diacetoacetate, polyethylene glycol diacetoacetate, polypropylene glycol diacetoacetate, cyclohexanedimethanol diacetoacetate, other diol diacetoacetates, trimethylol propane triacetoacetate, pentaerythritol triacetoacetate, glycerol trisacetoacetate, trimethylolethane triacetoacetate, other triol triacetoacetates, diacetoacetates of triols, tetra-, penta-, and higher acetoacetates of polyols (i.e., polyols on which four, five, or more hydroxyl groups are linked to acetoacetate groups through ester linkages), pentaerythritol tetraacetoacetate, glucose tetraacetoacetate, glucose pentaacetoacetate, dipentaerythritol pentaacetoacetate, and dipentaerythritol hexaacetoacetate; and
(b) the multi-functional Michael acceptor is selected from one or more of residues of (meth)acrylic acid, (meth)acrylamide substituted versions thereof, combinations thereof, capable of attaching to the multi-functional Michael acceptor molecule through an ester linkage or a poly-functional (meth)acrylate, 1,4-butanediol diacrylate, 1,6-hexanediol diacrylate, neopentyl glycol diacrylate, diethylene glycol diacrylate, triethylene glycol diacrylate, tetraethylene glycol diacrylate, polyethylene glycol diacrylate, dipropylene glycol diacrylate, tripropylene glycol diacrylate, cyclohexane dimethanol diacrylate, alkoxylated hexanediol diacrylate, alkoxylated cyclohexane dimethanol diacrylate, propoxylated neopentyl glycol diacrylate, trimethylolpropane triacrylate, di(trimethylolpropane) tetraacrylate, ethoxylated trimethylolpropane triacrylate, propoxylated trimethylolpropane triacrylate, acrylated polyester oligomer, bisphenol A diacrylate, diacrylate of diglycidyl ether bisphenol-A, ethoxylated bisphenol A diacrylate, tris(2-hydroxyethyl) isocyanurate triacrylate, acrylated aliphatic urethane oligomer, acrylated aromatic urethane oligomer, and mixtures thereof.

6. The foam sandwich as recited in claim 5, wherein:
the Michael acceptor is selected from diacrylate of diglycidyl ether bisphenol-A, di(trimethylolpropane) tetraacrylate, and mixtures thereof; and
the Michael donor is selected from trimethylolpropane acetoacetate, 1,1,3,3-tetramethylguanidine, and mixtures thereof.

7. The composite foam sandwich as recited in claim 1, wherein the silicone foam comprises ePP, ePS, aerogel, or any combination thereof.

8. A method of making an acrylic silicone foam composite, comprising:
(a) forming a first foam layer comprising predominantly silicone by mixing at least one foamable silicone pre-polymer with at least one blowing agent selected from fluorinated or non-fluorinated compounds, and curing the mixture to form a silicone foam;
(b) forming a second foam layer comprising predominantly acrylic by reacting a mixture comprising at least one multi-functional Michael donor, at least one multi-functional Michael acceptor, and at least one base catalyst to form an acrylic foam; and
(c) combining the silicone foam and the acrylic foam to form a composite foam sandwich structure.

9. The method of claim 8, wherein the blowing agent for the silicone foam is selected from methylal, ethylal, propylal, butylal, cyclopentane, pentane, methyl formate, and Opteon™ 1100.

10. The method of claim 8, wherein the silicone foam further comprises additives selected from expanded polypropylene (ePP), expanded polystyrene (ePS), aerogel, and mixtures thereof.

11. The method of claim 8, wherein the multi-functional Michael donor is selected from methyl acetoacetate, ethyl acetoacetate, t-butyl acetoacetate, 2-acetoacetoxyethyl (meth)acrylate, butane diol diacetoacetate, trimethylolpropane triacetoacetate, and mixtures thereof.

12. The method of claim 8, wherein the multi-functional Michael acceptor is selected from diacrylate of diglycidyl ether bisphenol-A, di(trimethylolpropane) tetraacrylate, trimethylolpropane triacrylate, and mixtures thereof.

13. The method of claim 8, wherein the composite foam sandwich comprises a structure selected from A1/B1, A1/B1/A2, B1/A1/B2, A1/B1/B2, A1/A2/B1, and A1/A2/B1/B2, where A designates a silicone foam and B designates an acrylic foam.
